(19) United States
(12) Patent Application Publication
(10) Pub. No.: US 2012/0010789 A1
(43) Pub. Date: Jan. 12, 2012

(54) PLANT PROCESSING MACHINE

(76) Inventor: Walter Dulnigg, Graz (AT)

(21) Appl. No.: 13/180,357

(22) Filed: Jul. 11, 2011

(30) Foreign Application Priority Data
Jul. 12, 2010 (AT) A 1176/2010

(51) Int. Cl. G06F 7/00

(52) U.S. Cl. 701/50

(57) ABSTRACT

A system for the cultivation, care and management of plants. At least one RFID tag is attached to the plants. A plant cultivation machine for reading plant data stored in the tags has an RFID reader and an assigned RFID antenna. The plant cultivation machine is formed, dependent on the read plant data of a tag of a plant, for selectively activating a work process of the plant cultivation machine for this plant. The plant cultivation machine has at least one cantilever that is substantially transverse to the drive direction of the plant cultivation machine and in a cultivation distance to the ground, substantially parallel to the ground. Dependent on the plant data read by the two RFID antennae the plant cultivation device is selectively activated for carrying out the work process at the plant to be cultivated and/or for registering/taking stock of the plant data read.

The invention relates to a system for the cultivation, care and management of plants, wherein there is attached at the plants to be cultivated a radio frequency identification (RFID) tag and wherein a plant cultivation machine has an RFID reader for reading the plant data stored in the tags and an assigned RFID antenna and wherein the plant cultivation machine is formed, dependent on the read plant data of a tag of a plant, for selectively activating a work process of the plant cultivation machine for this plant.

The document EP 1 762 135 A1 discloses such a system for the cultivation, care and management of plants, wherein there are cultivated in particular coniferous trees on a plantation with a size from small tree cuttings up to saleable Christmas trees. The system comprises a tractor as a plant cultivation machine having an RFID reader. On the one side of the tractor, there is attached the RFID antenna assigned to the RFID reader in order to read the tags attached at the Christmas trees without any contact. On the same side of the tractor, there is provided a saw, by means of which it is possible to cut a Christmas tree. According to the plant data stored in the tag of the Christmas tree, and read by the RFID reader, a control device of the RFID reader controls the saw in order to cut or trim, respectively, the desired Christmas tree with the read tag. There is further disclosed in the document that, according to the plant data read, it is also possible to selectively fertilize Christmas trees.

The known system has proved disadvantageous insofar as the plants have to be planted in relatively large distances to each other, in order to enable the tractor to drive through each plant row to selectively cultivate the plants. In this way, the plantable area cannot be worked on optimally in order to cultivate as many plants as possible. Furthermore, it has been shown that driving along every individual plant row for selectively cultivating only individual plants is rather time- as well as cost-intensive. Driving along every individual plant row for selectively cultivating individual plants is disadvantageous insofar as the soil becomes uneven and slushy due to the weight of the tractor—in particular in the case of moist weather, which in turn leads to soiling of the Christmas trees by the wheels of the tractor. The known system further has the disadvantage that taking stock of the plants existent on the plantation can be carried out only in a difficult and complex way.

The invention is based on the task to provide a system for the cultivation, care and management of plants, wherein the above mentioned disadvantages are prevented.

According to the invention, this task is solved by the plant cultivation machine having at least one cantilever that is substantially transverse to the drive direction of the plant cultivation machine, in a cultivation distance to the soil and substantially parallel to the soil and that is provided with a plant cultivation device and at which there are provided at least two RFID antennae spaced apart by an antenna distance and by the plant cultivation machine being formed in the system, dependent on the plant data read by the RFID antennae in order to selectively activate the plant cultivation device for carrying out the work process at the plant to be cultivated and/or for taking stock of the plant data read.

Hereby there is achieved the advantage that the plant cultivation machine with its cantilever spans over several plant rows and hence can cultivate in parallel or selectively plants in these plant rows. By making provision of at least two or several RFID antennae spaced apart on the cantilever there is achieved the advantage that the entire area under the cantilever is covered by the reading ranges of the RFID antennae and, hence, all tags attached at the plants under the cantilever can be read. As a consequence, the plant cultivation device on the cantilever can be activated or deactivated selectively for carrying out a work process. For example, only every third or fifth plant row has to be configured or driven through, respectively, in a larger width in order to enable the plant cultivation machine to drive through, in this way increasing the yield of the plantation. Furthermore, there is also produced less mud and soiling of the plants by the plant cultivation machine, and the work process is substantially accelerated and cost-optimized.

With the same plant cultivation machine, it is also possible to take stock of the plants on the plantation, wherein all read plant data are stored and radio-synchronized with a centralized logistics point. Hereby, plant data, which have not been registered in the system so far, may also be registered anew. This saves costs and time as, by driving through a plant row only once, it is possible to selectively cultivate several plant rows and take stock of the plants in the plant rows, and, if necessary, also register these completely anew.

If the plant cultivation machine is to be used for spraying fertilizers or pesticides, it has proven to be advantageous to provide several dispensing units or spray nozzles, respectively, at the cantilever. The spray nozzles are then selectively activated, if there is read a tag by the RFID antenna arranged in the immediate vicinity of the spray nozzle, according to the plant data of which there is provided the work process of fertilizing or spraying pesticides.

If the plant cultivation machine is to be used for trimming or cutting plants, it has proven to be advantageous to provide several cutting devices or cutting tools, respectively, such as for example retractable saws, at the cantilever. The saws are then selectively activated, if there has been read a tag by the RFID antenna arranged in the immediate vicinity of the saw, according to the plant data of which there is provided the work process of trimming or cutting.

It is especially advantageous to provide RFID antennae with an aligning tool at a cantilever with cutting devices, by means of which it is possible to detect the position of the tag of plant to be trimmed or cut. This positional information may then be used by the cutting device in order to position the saw of the cutting device dependent on the trunk of the plant or the branches of the plant.

It is further advantageous to control the RFID antennae at the cantilever in a multiplex procedure by means of only one RFID reader. In this way, there is obtained a low-cost solution.

The efficiency obtainable with the plant cultivation machine may even be further increased, if there are provided at both sides of the plant cultivation machine cantilevers with RFID antennae with the plant cultivation device that may be selectively activated.

By providing the tags essentially in the upper half of the plants, there is obtained the advantage that the cantilevers—according to the current height of the plants—will always guide above the tops of the plants and that also a relatively limited reading range of the RFID antennae is sufficient to reliably read the tags. The tags, hence, will be reliably read, irrespective of the size of the plants. Hereby, it is especially advantageous that the reading range does not reach the ground and, hence, tags, which have dropped off the plants or which have been scattered by the marker (workers marking the plants with tags), and tags lying on the ground will not be read. In this way, it is prevented that the tags lying on the ground are identified as plants still existent on the plantation, this making it possible that the process of taking stock of plants existent on the plantation is carried out in an unambiguous and especially reliable way.

In order to cover a reading range on the cantilevers as large as possible by means of as few RFID antennae as possible it is advantageous to determine the antenna distance so that the reading ranges of the RFID antennae at least slightly overlap in the height of the tags to be read in order to read all tags attached at the plants in a reliable way. The reading range of the RFID antenna is dependent, among others, on the chosen type of antenna and on the chosen transmission frequency in the LF, HF or UHF frequency range. Furthermore, it depends on to which cultivation distance from the ground the cantilevers are adjusted and on the current height of the plants, as both factors exert influence on the distance between the RFID antennae and the tags at the plants to be read.

It has proven to be advantageous to provide position determination means, this is, for example, a GPS receiver, at the plant cultivation machine or at the cantilever. It has proven to be, however, especially advantageous to attach several GPS receivers at the cantilevers assigned to the respective RFID antennae. This achieves the advantage that, in the case of taking stock of the plants on the plantation, there will also be stored the respective position of the individual plant. During stocktaking there is, hence, assessed, which tags or which plants, respectively, are detected by the RFID antennae while driving through the plantation, and the read plant data are stored in combination with the essentially simultaneously acquired GPS position data. It is possible to elaborate a list of all plants existent on the plantation with these acquired data, with the list additionally stating the precise position of the individual plant or the plantation section the plant is assigned to, respectively. There may also be displayed or printed a map of the plantation, wherein all plants currently existent on the plantation or only the plants marked by RFID labels (containing the tags) (plants prepared for sale) are included. This has the further advantage that it is possible to retrieve online, at any point of time during harvest, how many plants of a certain class have been harvested and how many plants are still existent in the plantation section still to be harvested. In this way, the plant owner gains precise information on his products during harvest season.

In the following the further advantageous embodiments of the system according to the invention will be explained in detail by way of the figures.

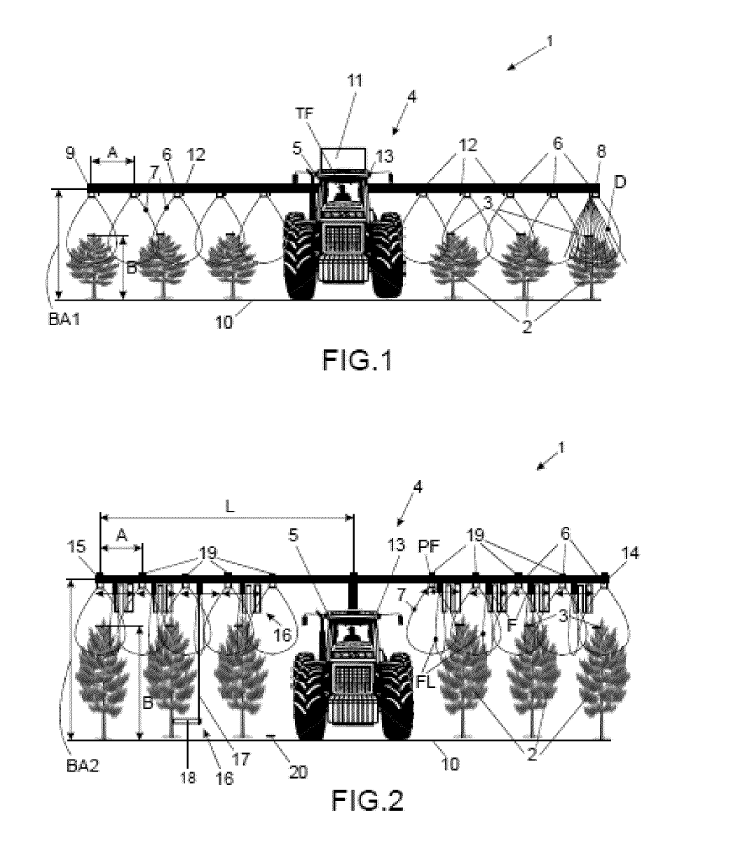

FIG. 1 illustrates a tractor with cantilevers for selectively fertilizing and taking stock of trees/plants.

FIG. 2 illustrates a tractor with cantilevers for selectively cutting trees, wherein there are provided in addition GPS receivers for stocktaking with accurate positional information.

FIG. 1 illustrates a system 1 for the cultivation, care and management of plants of a plantation. On the plantation, there are planted cuttings of small trees 2 and cultivated for several years in order to cut the trees 2 at the desired height of, for example, 1.5 m to 3 m height and to sell these as Christmas trees. On such a plantation, there may, however, also be cultivated other plants, such as, for example, boxwood and deciduous trees.

With the system 1 according to FIG. 1, every tree 2 is marked with a radio frequency identification (RFID) tag 3. Each of the tags 3 has a memory for storing plant data, which may be read by an RFID reader without any contact. The RFID technology has been known for a considerable time, for which reason there will not be provided further detailed information thereto. As plant data there may be stored, for example, the following data in the tag 3: date at which the cutting was planted; size of the cutting when it was planted; type of the plant; origin of the plant; customer for whom the plant is cultivated. In each tag 3 there is stored, however, a distinctive and unambiguous product code as plant data, by means of which each tag 3 may be unambiguously identified.

The system 1 further comprises a computer not displayed in the figures, wherein there are also stored the plant data in the tags 3 used in the system 1. Tags 3, the plant data of which are stored in the computer, are tags that are registered in the system 1. According to the implementation of the system 1, there may be stored in the tag 3 all relevant plant data or also only the unambiguous product code as a minimum variant of the plant data. In the case of this minimum variant, all plant data of a registered plant are then stored in the computer in any case. It, hence, suffices that the tag 3 may be unambiguously identified on the basis of its unambiguous product code in order to determine the residual plant data from the computer.

The system 1 additionally contains a tractor 4 as a plant cultivation machine, by means of which the work processes such as fertilizing, spraying or trimming/cutting of the trees 2 are carried out. The tractor 4 has an RFID reader 5 and in total ten RFID antennae 6 assigned to the RFID reader 5. Every RFID antenna 6 has a certain reading range 7, in which there is emitted an electromagnetic field with sufficiently large field intensity by the RFID antenna 6 in order to read the passive tags 3 situated within the reading range. The RFID reader 5 uses the ten RFID antennae 6 in a multiplex procedure, wherein the RFID reader 5 controls one RFID antenna 6 after the other in order to determine whether there is situated a tag 3 within the reading range 7 of the respective RFID antenna 6. If a tag 3 responds to the request by the RFID reader 5, then the stored plant data, this is at least the product code, of the tag 3 is read and stored in the RFID reader 5 for further processing.

The tractor 4 then has further two cantilevers 8 and 9, which extend transversely to the drive direction of the tractor 4 in a cultivation distance BA1 and in parallel to the ground level or soil 10, respectively. On the cantilevers 8 and 9 there are attached ten RFID antennae 6, wherein these are attached spaced apart from each other by an antenna distance A. Hereby, the reading ranges 7 of the RFID antennae 6 overlap in the area under the cantilevers 8 and 0, by the tags 3 being attached at the trees 2.

The tractor 4 with the cantilevers 8 and 9 is provided and formed for fertilizing individual trees 2. Therefore, the tractor has a tank 11 containing the liquid fertilizer. A plant cultivation device is connected with the tank 11, which is formed by ten spray nozzles 12, tube connections with the tank 11 and a control device 13 for the spray nozzles 12. For spraying, individual or also all of the spray nozzles 12 may be opened and also closed by the control device 13. As in this embodiment the spray area D of a spray nozzle 12 is more or less equivalent to the reading range 7 of the RFID antenna 6, exactly one of the spray nozzles 12 is assigned to each RFID antenna 6.

According to an example of use of the system 1 there is made the assumption that 200 pieces of trees 2 of different tree types with an age of four years or a height of at least 2.5 m, respectively, were cultivated on the plantation. Delivery is projected in three months' time. These trees 2 now have to be selectively fertilized once more in order to have especially green needles in three months' time.

According to the list of all trees 2 on the plantation stored in the computer, the 200 trees that are the most suitable ones are selected, wherein there are used general search criteria in data bases. The unambiguous product codes of the tags 3 of the selected trees 2 are stored by the computer in a storage medium (e.g., USB stick, SD card, . . . ), which the tractor driver TF is given before he starts working, or these are transmitted to the tractor from the switch board by means of radio (e.g., GSM), respectively. The tractor driver TF places this storage medium into the control device 13 of the plant cultivation device and starts to drive along the plant rows of the plantation. The cantilevers 8 and 9 each span, e.g. three plant rows, wherein there are planted in each of the plant rows trees 2 one after the other in a row. The RFID reader 5 controls one RFID antenna 6 after the other RFID antenna 6, continuously reads the unambiguous product code of the tags 3 of the trees 2 and stores these data. The control device 13 compares then the serial numbers read by the RFID reader 5 with the product codes of the tags 2, which are stored on the storage medium or transmitted by radio, respectively, and which are to be fertilized. If the control device 13 determines consistency, it then controls that spray nozzle 12 for spraying the fertilizer, which is assigned to the RFID antenna 6 having read the serial number of the tag 3. Thereby is achieved the advantage that selectively exactly those 200 trees of the plantation are fertilized, which are supposed to be cut in three months' time.

In a simpler embodiment of the system it would also be possible to control all spray nozzles 12 on one of the cantilevers 8 or 9 in order to spray fertilizer, if only one of the RFID antennae 6 on this cantilever 8 or 9 reads a tag 3 with a serial number consistent with the stored product codes of the tags 3. In this case, there would probably also be fertilized trees 2, which would not need or at least not at this time to be fertilized; the plant cultivation device, however, could be designed especially simple with only one tube from the tank 11 to the spray nozzles 12 of the cantilever 8 and 9.

In FIG. 2 the tractor 4 is illustrated according to FIG. 4, wherein it is re-configured for cutting the trees 2. Therefore, the tank 11 was removed and two other cantilevers 14 and 15 were mounted, on which there is provided as plant cultivation device a cutting device 16 assigned to each RFID antenna 6. For each cantilever 14 and 15 there are assigned four cutting devices 16 to the five RFID antennae 6, wherein the same cutting device 16 is assigned to the two outer two RFID antennae 6 per cantilever 14 or 15. The cutting devices 16 comprise a folding arm 17 and a saw 18. The control device 13 is formed for folding the arm 17 and for actuating the saw 18 in order to cut trees 2.

The cutting devices 16 each have one ferrite antenna F, defined by a special alignment characteristic of the electromagnetic field emitted. This alignment characteristic is provided by the fact that the reading range FL is formed as a very narrow club/narrow cylinder. The ferrite antennae F are slidingly arranged on the cantilever 14 and 15 horizontally in the direction of the arrow PF, wherein a motor adjusts the horizontal position of the respective ferrite antenna F according to control information provided by the control device 13.

According to the above example of use, there is made the assumption that now the 200 pieces of trees 2 are to be trimmed and/or cut and delivered. The tractor driver TF again takes the serial number of the 200 trees 2 of the order issued three months ago, which have been stored on the storage medium, and he places this into the control device 13 of the tractor 4 adapted to cut the trees 2. Consequently, it adjusts the height of the cantilevers 14 and 15 to the cultivation height BA2 in order to not touch the tree tops with the retracted arms 17 and at the same time drive along the tags 3 with its RFID antennae 6 to safely read all the tags 3 attached to the trees 2.

Thereafter, the tractor driver TF again drives through the plant rows, and the RFID reader 5 reads all tags 3 within the reading range 7 using the RFID antenna R. If the comparison of the serial numbers read by the RFID reader 5 with the serial numbers stored in the USB stick provides consistency, the control device 13 then controls the cutting device 16 in such a way that the arm 17 extends and that the saw 18 cuts off or trims the selected tree 2 slightly above the ground 10.

In order to detect the exact position of the trunk of the tree 2 to be cut/trimmed, the RFID reader 5 applies an electromagnetic field to the ferrite antenna F of the cutting device 16 before cutting/trimming, and the control device 13 changes the horizontal position of the ferrite antenna F in the direction of the arrow PF until the stored product code has been received by the reader, without any errors and with maximum “return signal strength” of the tag 3. As this is only possible in the narrow/cylindrical reading range FL, the control device 13 thereby knows the exact position of the tag 3 and, hence, also the exact position of the trunk of the tree 2 to be cut/trimmed. Using this information, the control device 13 can then especially precisely control the cutting device 16 for cutting/trimming the tree, in practice having enormous advantages, as the state of the art provides only for a manually performed, time-consuming and not precise positioning of the cutting device.

Thereby is obtained the advantage that trees 2 selected by the computer are then selected by the tractor 4 and precisely cut/trimmed, wherein only one tractor driver is required to drive along the plant rows, and additional persons for manually activating and controlling the cutting device on the tractor are not required anymore.

Plants may be selected for a work process by the plant cultivation machine in different ways. For example, the computer might select in an automatized search process all trees 2, which have been planted 3 years ago. Or there might be selected all trees 2, which belong to a certain kind of tree, or there might be selected all deciduous trees. According to the desired option, the respective information would be stored as plant data in the computer and/or in the tags 3 at the trees 2. As soon as the trees 2 are selected for a work process and a respective list of the product codes has been delivered to the control device 13, the desired work process may be performed at the selected trees 2.

The system 1 is especially advantageously for use if the cantilevers have a sufficiently large length L. Cantilevers with a length of 5 m, 10 m or even 20 m span already across several rows of plants, for which reason it is possible to save time, costs and mud/soiling/damage by the tractor in the course of plant cultivation.

It is also an advantage to attach the tags 3 in the upper half or top, respectively, of the trees 2 and to adapt the reading range 7 of the RFID antennae 6 so as to not reach the ground 10. Thereby is obtained the advantage that a tag 20 fallen off the tree 2 or tags 20 having been dropped/scattered by the marker will not be read by the RFID reader 5, this guaranteeing an exact stocktaking of the available plant products. The current state of the art solves this problem by the markers manually stating how many labels they have attached in which plantation section. This, however, leads to serious inaccuracies through, e.g., lost labels or inaccurate manual recordings. The invention, furthermore, also provides for a precise inspection and performance monitoring of the markers.

It is to be noted that the tags 3 are attached at the trees 2 very rigidly by means of a label made from plastics or an RFID label, which virtually cannot drop off. This, however, may occur when a tree 2 is cut, for which reason unnecessary work processes are prevented by the reading ranges 7 not reaching to the ground 10.

It is also especially advantageous to design the suspension of the cantilevers so that the cultivation distance may be adjusted in order to being able to reliably read the tags 3 attached to the top of the trees 2, irrespective of the respective tree height B. The tractor driver may execute this process hydraulically and/or pneumatically while driving.

Furthermore the system 1 and the tractor 4 are advantageous in so far as, while driving along the plant rows of the plantation in order to cultivate the selected trees 2, all plant data read by the RFID antennae 6 may be stored using the RFID reader 5. This list of the plant data of all tags 3 or trees 2, respectively, existent on the plantation is a stock list providing a survey of all the trees 2 existent on the plantation. In this way, there is, simply and without any additional costs, taken stock of the trees 2 when the tractor 4 drives through the plantation. All plant data of all standing—this is, alive—trees 2 are stored. These stock data may be transmitted to the computer from the RFID reader 5 (e.g., USB stick or other storage medium or by means of radio, . . . ) and be processed further therein.

It is especially advantageous to attach position determination means, this is in particular several GPS receivers 19, each at the substantially same position as the RFID antennae 6 at the cantilevers 14 and 15, as is shown in FIG. 2. The GPS receivers 19 are connected with the RFID reader 5, which correspondingly stores plant data read by the RFID antennae 6 (e.g., product code: 223453245) together with the GPS position data read at the associated GPS receiver 19 (GPS: 16.252 O/48.178 N). Thereby, there is obtained the advantage that the tractor 4 has to drive through the plant rows of the plantation only once in order to take stock of the trees 2 on the plantation with their current position in the plantation. There is provided thereby an especially simple and reliable possibility for taking stock of the plants in a plantation.

According to a further embodiment of the invention, there is made the assumption that the trees in the plantation are only then registered when they have reached a suitable height and growth form for sale. For example in summer workers could walk through the plantation and attach RFID labels with tags at those trees which are suitable as Christmas trees already in this year. For example red RFID labels could identify pines with a quality 1 with a height between 2 m and 2.5 m, and green RFID labels could identify spruces with a height between 1.5 m and 2 m. Further colour markings or height class codes (1=<1 m, 2=1-1.25 m, . . . 9=>2.25 m), respectively, of the RFID labels would then identify further tree types and/or heights of the trees and/or resellers (customers) of the trees. The RFID labels contain tags, in which plant data are stored that contain the respective markings of the tree in electronic form. Also in the tag of the red RFID label there would be stored plant data identifying the tree as a pine with a height between 2 m and 2.5 m.

After the workers have walked through the plantation in summer and have marked all trees that could be sold as Christmas trees this year using RFID labels, the tractor driver drives with the tractor through the plantation and registers all tags in the RFID labels at the trees in the system. As there have not been registered any tags in the system before, there is simultaneously obtained also a first stocktaking of all saleable trees. The manager of the plantation thereby immediately knows that this year there could be sold, for example, 1,325 trees as Christmas trees and that there are included, e.g. 233 pines with a height between 2 m and 2.5 m. This substantially simplifies the administration work related with the trees of the plantation, plannability/realization of customer orders, logistics, commissioning and the sale of the trees. Also during harvest, the administrator/logistician of the plantation is provided with a current stock list of the saleable trees still existent on the plantation, whenever the tractor drives through the plantation.

It is to be noted that the plant cultivation machine need not be formed by a tractor. It would, for example, be possible that there were arranged trails in the plant rows, on which a motorized mobile, automatically driven by the computer, may drive along the plant rows and selectively perform the work processes.

It is to be noted that the cutting device may also be formed for automatically trimming the form of the plants. There could, for example, be formed individual of the trees 2 by boxwood trees, and the cutting device 16 could selectively trim these trees 2 into a conical/spherical form. The automatized trimming of the trees 2 may only be realized by the above described position determination of the tag 3 at the tree 2 by the ferrite antennae F. So if a boxwood tree is to be trimmed in a conical form, this may be carried out with the help of a machine in consideration of the position of the trunk of the boxwood tree.

It is to be noted that there need not necessarily be provided RFID antennae 6 and for each cutting device 16 in addition a respective ferrite antenna F. Persons skilled in the art are aware of techniques to restrict the reading range of an RFID antenna. Hence, initially the RFID antennae 6 with their overlapping reading ranges 7 could detect the tags 3 on the trees 2, and then, when one of the trees 2 is supposed to be cut, the reading range 7 of the RFID antenna 6, which has detected the tag 3 of the tree 2 to be cut, could be restricted to a narrow reading range in order to detect the exact position of the tag 3. Therein there would be obtained a low-cost embodiment of the invention.

There is to be noted that plant cultivation devices may carry out different work processes.

For example a plant cultivation device could be formed for planting cuttings of plants. The plant cultivation device could plant a cutting at positions in the plant rows, where there is not detected a tag, this is which are free. This plant cultivation machine could also simultaneously attach the tag at the top of the cutting and register the plant data in the system in an automatized way.

It is to be noted that several plant cultivation devices (e.g., spray nozzles; cutting devices, planting devices) can be assigned to an RFID antenna, and also only one plant cultivation device could be assigned to several RFID antennae. This depends on the respective tool and the cultivation process.

It is to be noted that the cantilever/s of the plant cultivation machine may also span across five, seven or even twenty plant rows. This is in particular possible in the case of artificially dwarfed or artificially narrowed plants, as in this case the plant rows may be designed rather close to each other. Furthermore, special constructions of the cantilevers are also possible, which are then designed especially long.

It is to be noted that the cantilever with the plant cultivation devices (e.g., cutting tools for trimming or cutting, respectively, the plants) may also be attached at the rear part of the tractor. Hence, it is possible that a cantilever, which is attached only at the rear part of the tractor, may extend to the left as well as to the right, transversely to the driving direction of the tractor.

1-10. (canceled)

11. A system for the cultivation, care and management of plants, wherein there is attached to the plants to be cultivated at least one radio frequency identification (RFID) tag, the system comprising:
a plant cultivation machine for reading plant data stored in the tags, the plant cultivation machine has an RFID reader and an assigned RFID antenna, wherein:
the plant cultivation machine is formed, dependent on the read plant data of a tag of a plant, for selectively activating a work process of the plant cultivation machine for the plant;
the plant cultivation machine has at least one cantilever that is substantially transverse to the drive direction of the plant cultivation machine, in a cultivation distance to the ground and substantially parallel to the ground, at which there is provided a plant cultivation device and at which there are provided at least two RFID antennae spaced apart by an antenna distance; and
the plant cultivation machine is configured, dependent on the plant data read by the two RFID antennae, for selectively activating the plant cultivation device for carrying out the work process on the plant to be cultivated and/or for taking stock of the plant data read.

12. A system according to claim 11, wherein the plant cultivation machine comprises a container provided at the cantilever dispensing units of the plant cultivation device for dispensing the plant cultivation means, wherein each dispensing unit is assigned at least one RFID antenna, and the plant cultivation machine is configured, dependent on the plant data read by the RFID antennae, for activating the assigned dispensing unit for dispensing the plant cultivation means to the plants intended therefore.

13. A system according to claim 12, wherein the plant cultivation means include fertilizers or pesticides.

14. A system according to claim 11, wherein cutting units are provided at the cantilever of the plant cultivation device for trimming and/or cutting the plant, wherein each cutting unit is assigned to at least one RFID antenna, and the plant cultivation machine is formed, dependent on the plant data read by the RFID antennae, for activating the assigned cutting unit for trimming and/or cutting the plants intended therefore.

15. A system according to claim 14, wherein there is provided at least one RFID antenna with alignment characteristics, in particular a ferrite antenna, which is formed for detecting the exact position of the tag and, hence, for exactly recognizing the plant centre of the plant to be trimmed and/or cut and that the cutting device is formed so that it may be positioned in the cutting process in consideration of the detected position of the tag.

16. A system according to claim 15, wherein the at least one RFID antenna includes a ferrite antenna.

17. A system according to claim 11, wherein there is provided only one RFID reader co-operating with all the RFID antennae provided at the cantilever in order to read the tags in the reading ranges of the RFID antennae.

18. A system according to claim 11, wherein the plant cultivation machine comprises two opposing cantilevers that are substantially transverse to the drive direction of the plant cultivation machine and in a cultivation distance to the ground, substantially parallel to the ground, wherein the two cantilevers are formed in particular as only one cantilever attached at the rear part of the plant cultivation machine.

19. A system according to claim 18, wherein the two cantilevers are formed as only one cantilever attached at the rear part of the plant cultivation machine.

20. A system according to claim 11, wherein the tags are attached essentially in the upper half of the plants and that the reading range of the RFID antennae is such adjusted or the cultivation distance is such adapted, respectively, so that the reading range of the RFID antennae does not reach the ground.

21. A system according to claim 11, wherein the antenna distance between the RFID antennae is such determined that the reading ranges of the RFID antennae completely cover the entire length of the cantilevers.

22. A system according to claim 11, wherein there is provided at least one position determination means at the plant cultivation machine and/or at least one position determination means at the cantilever, which is formed for determining the current GPS positional data, wherein the plant cultivation machine is formed for assignedly storing the read plant data and determined GPS positional data.

23. A plant cultivation machine for the cultivation, care and management of plants, wherein the measures are provided at the plant cultivation machine according to claim 11.
